(19) United States
(12) Patent Application Publication
(10) Pub. No.: US 2026/0043972 A1
(43) Pub. Date: Feb. 12, 2026

(54) WAFER-LEVEL OPTICS

(71) Applicant: HEPTAGON PHOTONICS PTE. LTD., Singapore (SG)

(72) Inventors: Bojan TESANOVIC, Unterentfelden (CH); Nicola SPRING, Oberterzen (CH); Sylvain GROSSMANN, Rüschlikon (CH)

(21) Appl. No.: 19/362,209

(22) Filed: Oct. 17, 2025

Related U.S. Application Data
(63) Continuation of application No. PCT/EP2024/060903, filed on Apr. 22, 2024.

(30) Foreign Application Priority Data
Jun. 16, 2023 (DE) 10 2023 115 814.7

(51) Int. Cl. G02B 6/42

(52) U.S. Cl. CPC G02B 6/4206; G02B 6/4244

(57) ABSTRACT

An optical component (200) including: a substrate (202) comprising a through-hole (206) extending from a first opening in a first surface (208a) of the substrate (202) to a second opening in a second surface (208b) of the substrate (202); and a lens element (204) at least partially embedded in the through-hole (206), wherein the substrate (202) is structured to define an aperture stop (212) of the optical component (200) in correspondence of the through-hole (206) to, during an operation of the optical component (200), partially block light and partially allow light to pass through the aperture stop (212), wherein the aperture stop (212) has a lateral dimension in a direction perpendicular to an optical axis of the optical component (200) less than a lateral dimension of a lens portion of the lens element (204) in the direction perpendicular to the optical axis of the optical component (200).

### TECHNICAL FIELD

The present disclosure relates generally to an optical component for use in an optoelectronic device, to an optoelectronic device including the optical component, and to methods thereof (e.g., a method of fabricating an optical component).

### BACKGROUND

In general, optoelectronic devices are devices capable of converting electrical energy into light, or vice versa, thus providing light emission functionalities and/or light detection functionalities. Common examples of optoelectronic devices may include light projectors and flood illuminators for light emission, photo diodes for light detection, and/or solar cells for converting solar light into electrical energy. Optoelectronic devices may therefore be used in a variety of application scenarios, both in industrial- as well as in home-settings. Application examples of optoelectronic devices may include telecommunications (e.g., fiber optic communications), three-dimensional sensing, medical instruments, optical memories, optical control systems, and/or the like. Improvements in optoelectronic devices may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A shows a light-based sensing device in a schematic view, according to various aspects;

FIG. 1B shows an optoelectronic device in a schematic representation, according to various aspects;

FIG. 2 shows an optical component in a schematic representation, according to various aspects;

FIG. 3A and FIG. 3B show possible configurations for the structuring of a substrate of the optical component in a schematic representation, according to various aspects;

FIG. 4A shows an optical stack including a plurality of optical components in a schematic representation, according to various aspects;

FIG. 4B shows an exemplary realization of an optical stack including a plurality of optical components in a schematic representation, according to various aspects;

FIG. 5A and FIG. 5B show a parallel fabrication of a plurality of optical components in a schematic representation, according to various aspects;

FIG. 5C and FIG. 5D show a parallel fabrication of a plurality of optical stacks in a schematic representation, according to various aspects;

FIG. 6 shows a schematic flow diagram of a method of fabricating an optical component, according to various aspects; and

FIG. 7A and FIG. 7B show an illustrative representation of a method of fabricating optical components, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., an optical component, an optoelectronic device). However, it is understood that aspects described in connection with methods may similarly apply to the devices, and vice versa.

Optoelectronics is at the intersection between optics and electronics, and deals with devices capable of emitting, detecting, and/or otherwise controlling light. Optoelectronic devices are used in a wide range of application areas. For example, in the current market, there is a growing trend towards three-dimensional (3D) sensing, for example for face authentication, movement-tracking, eye-tracking, and the like. For this type of application, optoelectronic illuminators may flood the targets with light, or optoelectronic projectors may project light dots onto the targets, and the light impinging onto the targets is imaged and measured.

In general, there are several desirable properties for an optoelectronic device. As an example, there is a constant trend towards miniaturization, aimed at minimizing the overall size of an optoelectronic module. In the context of small-footprint optical systems, wafer-level optics is a technique for fabricating miniaturized optical components, such as wafer-level lenses. Wafer-level optics may illustratively describe the use of techniques typical of the semiconductor industry for manufacturing optical components. Wafer-level optics is commonly exploited for camera modules, e.g. for integration in portable devices such as tablets, smartphones, and the like. In general, aspects related to wafer-level optics and corresponding fabrication techniques are well known in the art. A brief description is provided herein to introduce aspects relevant for the present disclosure.

Wafer-level optics may be based on processes typical of semiconductor manufacturing, such as thin film deposition, lithography, etching, molding, imprinting, and the like. For example, in wafer-level optics, optical elements may be fabricated using molds, which enables mass production. As an abridged overview, wafer-level optics may include imprinting to fabricate optical components at the wafer-level, and then a layer by layer stacking of the individual optical components to assemble the final product. The resulting optical module may finally be coupled, e.g. bonded, with an image sensor (e.g., a CMOS image sensor) at the wafer-level. Wafer-level optics may thus allow producing optical modules with a reduced footprint compared to other fabrication techniques.

The fabrication of an optical component via wafer-level optics techniques may include a master stamp designed according to the configuration (e.g., shape, size, etc.) of the optical components to be fabricated. The master stamp may allow transferring the desired pattern into a curable material, such as an optical polymer material, which may then be cured via irradiation with ultraviolet (UV) light. A suitable approach for wafer-level optics may include a so called “step-and-repeat ultraviolet imprint lithography”, in which individual molds for the optical components are replicated on a substrate (e.g., a wafer) using high precision alignment. The stamp (e.g., the master stamp, or a corresponding working stamp) may define the shape of a curable polymer disposed on the substrate, and the subsequent irradiation (e.g., via UV light) may cure the polymer in the desired shape. Typical deposition methods may include puddle dispense or ink jet dispense.

After curing, further processing steps may be carried out to finalize the optical components. Such further processing steps may be carried out at the wafer-level, thus providing an efficient and streamlined procedure for the completion of the optical component. The further processing steps may include, for example, de-molding, cleaning, polishing, edge removal, coating, and stacking. Wafer-level optics may include stacking the wafers including the individual optical components, e.g. via wafer bonding, to provide an optical module having the desired number and arrangement of optical elements. Wafer-level optics may further include dicing the wafer stack to provide individual optical modules, e.g. to be placed and coupled with an image sensor.

In wafer-level and monolithic lens molding different challenges arise. Wafer-level manufacturing creates an easy-to-handle sheet/array of lenses on a wafer that allows parallelization of downstream processing. This makes the integration of additional optical features such as apertures much simpler as these structures can be created as a layer on the wafer before lens molding. However, wafer-level molding has limitations in relation to possible lens shapes. This limitation of can be overcome by molding a monolithic lens element without the glass sheet in-between. This approach has however the drawback that the handling is more difficult as lenses are no longer connected to one another and therefore the downstream processing becomes more difficult to parallelize. In addition, this makes it difficult to integrate an aperture as this can no longer be done over a layer on the glass.

The present disclosure may be based on the realization that the substrate on which a lens fabricated via wafer-level manufacturing is disposed may be structured to form an aperture stop for the lens. This approach may provide integrating the aperture stop within the lens-component without the need for introducing additional (separate) elements/layers, but rather using the substrate itself. Illustratively, the strategy described herein may include shaping the substrate in correspondence of the lens portion of the lens in such a way that the substrate (e.g., a wafer, or a sheet) defines an aperture stop for the lens. The strategy described herein provides thus a more compact arrangement, which may facilitate the integration of the optical component in systems for which a reduction of the overall dimensions play an important role, such as mobile communication devices, augmented reality sensors, virtual reality sensors, and the like.

According to various aspects, an optical component may include: a substrate (e.g., a wafer or a portion of a wafer) with a through-hole extending from a first opening in a first surface of the substrate to a second opening in a second surface of the substrate; and a lens element at least partially embedded in the through-hole, wherein the substrate is structured to define an aperture stop of the optical component in correspondence of the through-hole to, during an operation of the optical component, partially block light and partially allow light to pass through the aperture stop. For example, the lens element may be formed in the through-hole, as discussed in further detail below.

According to various aspects, a method of fabricating an optical component may include: forming a through-hole in a substrate (e.g., in a wafer), the through-hole extending from a first opening in a first surface of the substrate to a second opening in a second surface of the substrate; providing (e.g., disposing or forming) a lens element at least partially embedded in the through-hole; and structuring the substrate to define an aperture stop of the optical component in correspondence of the through-hole to, during an operation of the optical component, partially block light and partially allow light to pass through the aperture stop.

By way of illustration, an optical component configured as described herein may include an aperture substrate that is configured/structured to be used as an aperture stop, thus providing a means for reducing stray light and scattering, as well as enabling light sealing to avoid light leakage from and to the ambient. The proposed optical component also allows a channel separation of multiple parallel optical paths such as a combination of multiple cameras side by side or a combination of an emitter path and receiver path in one package. The proposed strategy thus solves the fundamental issues mentioned above in relation to wafer-level lenses by providing a monolithic structure that uses an interconnecting substrate (e.g., a sheet) as an aperture for the optical system.

The proposed approach may be implemented with/in different types of substrates, such as a wafer (e.g., an epoxy wafer) or a sheet. In case of a non-transparent substrate (e.g., an opaque substrate), the aperture may be defined without the need for side wall coating. The aperture stop may be formed by structuring the substrate with any suitable technique, e.g. laser drilling, micromachining, etching, and the like, and may be formed as part of the substrate (e.g., as part of the wafer), without the need for additional elements (e.g., without the need for an additional layer defining the aperture, e.g. a black chromium layer). This may allow achieving an overall lower cost for the optical component, together with the more compact design.

In the context of the present disclosure, particular reference may be made to the use of the (wafer-level) optical component described herein as part of an optoelectronic device as this may be a relevant use case (e.g., in view of the miniaturization enabled by the design proposed herein). It is however understood that the optical component described herein (or a stack of such optical components) may be introduced (e.g., integrated) in other types of devices, e.g. imaging devices, in which an overall miniaturization may be advantageous. Examples of imaging devices in which the optical component may be integrated may include a time-of-flight sensor, a stereo vision sensor, a disparity-based sensor, and the like.

An optoelectronic device including the optical component may be integrated in a host device that exploits the optoelectronic device to implement one or more functionalities (e.g., telecommunications, distance measurements, object tracking, and the like). Exemplary host devices for the optoelectronic device may include a mobile communication device (e.g., a smartphone, a tablet, a laptop), a vehicle (e.g., a car), an automated machine (e.g., a drone, a robot), and the like.

Wafer-level techniques may provide a convenient fabrication strategy for providing an optical component configured as described in the following. It is however understood that in principle also other types of fabrication methodologies may be used to provide an optical component configured according to the proposed strategy, e.g. fabrication techniques that do not rely on semiconductor-like fabrication processes.

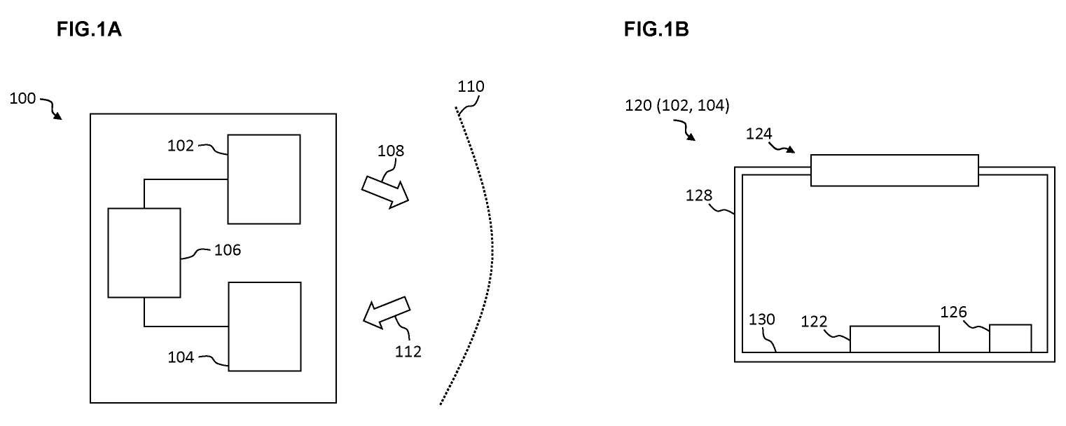

FIG.1A shows a light-based sensing device 100 in a schematic representation, according to various aspects. The device 100 may be an exemplary device that includes one or more optoelectronic devices for light emission and/or light detection. The device 100 provides an exemplary and simplified configuration of a possible application of an optical component (and optoelectronic device) as described herein. In general, the light-based sensing device 100 may include a first optoelectronic device 102 configured to emit light, and a second optoelectronic device 104 configured to detect light. The device 100 may further include a processing circuit 106 configured to control an operation of the device 100, e.g. the processing circuit 106 may be configured to control a light emission by the first optoelectronic device 102 and may be configured to process data related to light detection by the second optoelectronic device 104.

In general, the device 100 may be configured for any desired application. In an exemplary configuration, which may represent a relevant use case for an optical component as described herein, the device 100 may be configured as a three-dimensional sensor, illustratively as a depth sensor. As other examples, the device 100 may be configured as a time-of-flight sensor, a proximity sensor, a stereo vision sensor, and the like.

The device 100 may be configured to carry out light-based sensing (or light-based detection) in a field of view 110. In this regard, the processing circuit 106 may be configured to instruct the light-emitting optoelectronic device 102 to emit light, e.g. the processing circuit may trigger or initiate a light emission by the first optoelectronic device 102. The first optoelectronic device 102 may emit light 108 towards a field of illumination of the first optoelectronic device 102. The field of illumination may at least partially overlap with the field of view 110 of the device 100, e.g. with the field of view of the light-detecting optoelectronic device 104. In some aspects, the field of illumination of the first optoelectronic device 102 may correspond to the field of view of the second optoelectronic device 104 (illustratively, the field of illumination may coincide with the field of view 110).

The first optoelectronic device 102 may be configured to emit light according to any suitable emission scheme, depending on the type of sensing/detection to be implemented. As an example, the first optoelectronic device 102 may be configured to emit light according to a predefined light pattern, e.g. a grid of light dots or a grid of lines. This configuration may be provided, for example, for face-recognition applications, in which the distortion of the emitted pattern is associated to the profile of an object (e.g., a person) in the field of view 110 of the device 100. As another example, the first optoelectronic device 102 may be configured to emit a light pulse, or a sequence of light pulses. This configuration may be provided, for example, for time-of-flight measurements, in which the round-trip time of the emitted light pulses is calculated to map the presence of objects in the field of view 110, and their properties such as distance from the device 100, speed, direction of motion, and the like.

The second optoelectronic device 104 may be configured to detect light 112. Illustratively, the second optoelectronic device 104 may be configured to receive light from the field of view 110, e.g. a back-reflection of the emitted light 108, and deliver a signal representative of the received light. As an example, the second optoelectronic device 104 may deliver a signal representative of a (distorted) pattern of the detected light 112. In this scenario, the processing circuit 106 may be configured to determine properties of the object that back-reflected the emitted pattern by analyzing the distortion (e.g., a phase variation between light dots in the emitted pattern and in the detected pattern). For example, the processing circuit 106 may be configured to reconstruct a shape of the object (e.g., a face) based on the distorted pattern. As another example, the second optoelectronic device 104 may deliver a signal representative of an arrival time of a light pulse at the second optoelectronic device 104. In this scenario, the processing circuit 106 may be configured to determine a time-of-flight of the light by using the emission time of the emitted light 108 and the arrival time of the reflected light 112, as known in the art.

It is understood that the representation in FIG. 1A may be simplified for the purpose of illustration, and that the light-based sensing device 100 may include additional components with respect to those shown. For example, the device 100 may include one or more amplifiers to enhance the light emission and/or light detection, one or more filters to select a wavelength bandwidth to reduce the impact of ambient light, transmitter optics, receiver optics, scanning elements (e.g., a MEMS mirror) to scan the field of illumination, analog-to-digital converters, and the like.

It is also understood that the aspects described in relation to the light-based sensing device 100 that includes an emitter path and a receiver path may apply in a corresponding manner to a configuration in which a device includes only an emitter path or only a receiver path. Illustratively, an optical component as described herein may be for use also in a device dedicated to one specific function, e.g. light emission or light detection.

FIG.1B shows an optoelectronic device 120 in a schematic representation, according to various aspects. The optoelectronic device 120 may be an exemplary configuration of the light-emitting optoelectronic device 102 or the light-detecting optoelectronic device 104 described in relation to FIG.1A. In general, the optoelectronic device 120 may include an active optoelectronic component 122 configured for emitting or detecting light, an optical component 124 to direct light towards a field of illumination or to direct light towards a light-detecting optoelectronic component, and a control circuit 126 to control an operation of the optoelectronic device 120. Illustratively, the optical component 124 may be optically coupled with the optoelectronic component 122 to receive light emitted by the optoelectronic component 122 or to direct light towards the optoelectronic component 122. It is understood that the optoelectronic device 120 may also include more than one active optoelectronic component 122, e.g. each associated with a corresponding optical component 124. For the sake of brevity the “active” optoelectronic component 122 may also be referred simply as optoelectronic component 122.

In this regard, the term “active” in relation to the optoelectronic component 122 may be used to indicate that the optoelectronic component 122 may implement an active function, e.g. may actively emit light upon receiving a corresponding signal (e.g., a driving current) or may actively detect light by generating a corresponding detection signal (e.g., a photo current). The term “active” may thus be used to distinguish the optoelectronic component 122 from other types of optoelectronic components that manipulate light in a passive manner, e.g. without the possibility of actively driving the optoelectronic component, e.g. via a corresponding driving signal.

In an exemplary configuration, the active optoelectronic component 122 may be configured to emit light. In this scenario, the optoelectronic component 122 may be or include a light source configured to emit light through the optical component 124. Illustratively, the optical component 124 may be configured to direct the light emitted by the light source into a field of illumination of the optoelectronic device 120 (e.g., a field of illumination of the device 100). The optical component 124 may be configured to define a field of illumination for the light source. Additionally or alternatively, the optical component 124 may be configured to project the light emitted by the light source as a light pattern (e.g., as a dot pattern).

As an example, the light source may be or include a laser source, e.g. a Vertical Cavity Surface Emitting Laser (VCSEL) or a VCSEL-array. The light source may be configured to emit light having a predefined wavelength, for example in the visible range (e.g., from about 380 nm to about 700 nm), infrared and/or near-infrared range (e.g., in the range from about 700 nm to about 5000 nm, for example in the range from about 860 nm to about 1600 nm, for example at 940 nm), or ultraviolet range (e.g., from about 100 nm to about 400 nm).

In other aspects, the optoelectronic component 122 may be configured for receiving/detecting light and generating a corresponding electrical signal, e.g. a corresponding electrical current. In this scenario, the optoelectronic component 122 may be or include a light sensor (e.g., a photo diode), e.g. as part of a detection system or as part of a solar cell, as examples. The light sensor may be configured to be sensitive for light having wavelength in a predefined range, e.g. one of the ranges described above in relation to the light source. As examples, a light sensor may include at least one of a PIN photo diode, an avalanche photo diode (APD), a single-photon avalanche photo diode (SPAD), or a silicon photomultiplier (SiPM). In this configuration, the optical component 124 may define a field of view of the light sensor, e.g. to collect light from the field of view and direct the collected light onto the light sensor.

According to various aspects, the control circuit 126 may include or may be coupled with a memory (not shown). For example, the memory may be part of the optoelectronic device 120. As another example, the memory may be external to the optoelectronic device 120 and the control circuit 126 may be communicatively coupled with the memory (e.g., with the cloud). The memory may store instructions for the operation of the optoelectronic device 120, and/or may store information representative of light detection at the optoelectronic device 120.

According to various aspects, the optoelectronic device 120 may include a substrate 130, and the optoelectronic component 122 may be integrated onto the substrate 130. For example, the substrate 130 may be a printed circuit board. In some aspects, the optoelectronic component 122 and the control circuit 126 may be integrated onto the same substrate 130. This configuration may provide a robust arrangement of the optoelectronic device 120. According to various aspects, the optoelectronic device 120 may include a housing 128. The housing 128 may enclose the optical component 124 and the optoelectronic component 122. The housing 128 may provide mechanical support to the optical component 124, e.g. the housing 128 may be prepared for placement of the optical component 124 (e.g., the housing may include a recess to accommodate the optical component 124). As examples, the housing 128 may be a plastic spacer, a ceramic substrate, an organic substrate, or a leadframe. The housing 128 may also be referred to as package element.

In an exemplary configuration, the optical component 124 may include a wafer-level lens, or a stack of wafer-level lenses. Illustratively, in this scenario the optical component 124 may include one or more lenses fabricated via wafer-level manufacturing. This configuration may facilitate a miniaturization of the optoelectronic device 120 while still providing a suitable optical function (e.g., for light emission or light detection). The term “wafer-level”, e.g. in relation to a “wafer-level lens” or “wafer-level optical component”, may be used herein to indicate that the corresponding entity is fabricated using wafer-level optics techniques, such as UV molding replication, lithography, etc., as discussed above.

As an example, a wafer-level lens may be configured as a plano-concave lens. In this configuration, the lens may include a planar (illustratively, flat) surface, and a concave surface. The lens may thus be a negative lens, illustratively a lens having a negative focal length. A plano-concave lens may be configured to provide beam expansion, e.g. may cause parallel input rays to diverge at the output side and may allow increasing the focal length of an optical system. As another example, a wafer-level lens may be configured as a plano-convex lens. In this configuration, the lens may include a planar (illustratively, flat) surface, and a convex surface (illustratively, a spherical surface). The lens may thus be a positive lens, illustratively a lens having a positive focal length. A plano-convex lens may be configured to provide beam focusing, e.g. may cause parallel input rays to converge at the output side. It is understood that wafer-level optics is not limited to the fabrication of plano-concave lenses or plano-convex lenses, and may be extended to lenses having another profile (illustratively, another shape of the lens portion). A stack of a plurality of wafer-level lenses may be provided to tailor an optical function by selecting which types of wafer-level lenses to put in the stack and the order with which the wafer-level lenses are disposed in the stack.

In general, a wafer-level lens may include or may be coupled with an optical substrate, e.g. a wafer or a sheet. Illustratively, the lens may be formed on the substrate, e.g. the lens may be in direct physical contact with the substrate. In a conventional configuration, the substrate may be a continuous substrate, e.g. without any structuring, to provide support to the lens.

The present disclosure may be based on the realization that a suitable structuring of the substrate of a (wafer-level) optical component may enable forming an aperture stop for the corresponding lens, thus providing an additional integrated functionality without the need for separate components. Furthermore, the structuring of the substrate allows flexibility in various properties of the aperture, e.g. dimension, shape, symmetry, and the like, thus allowing to tailor the aperture to desired properties, e.g. for a specific application of the optical component, e.g. for use in a specific type of optoelectronic device.

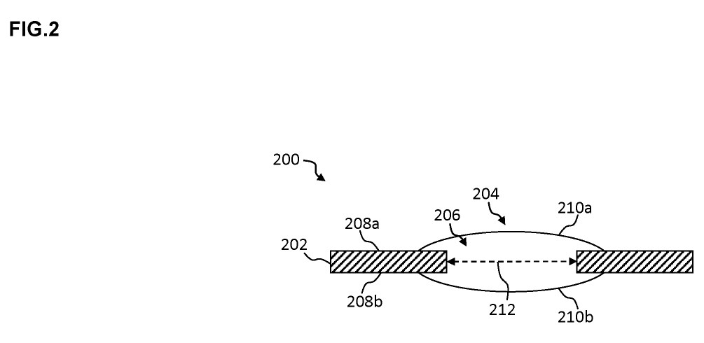

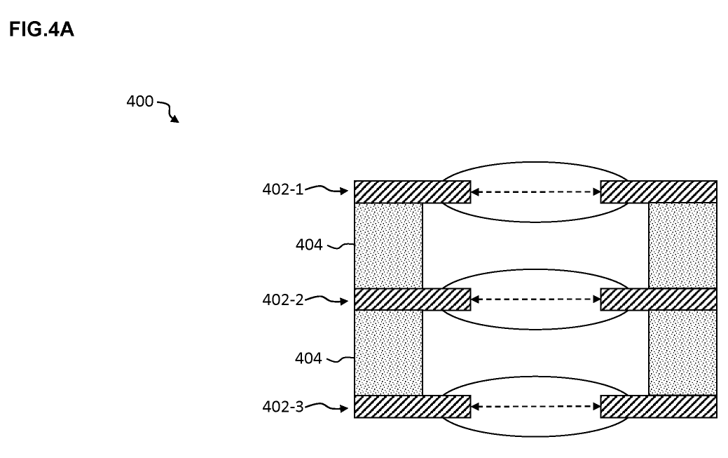

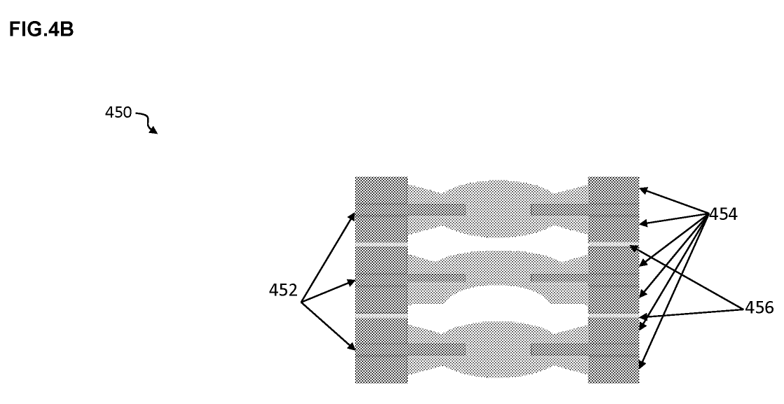

FIG. 2 shows an optical component 200 in a schematic representation, according to various aspects. The optical component 200 may be an adapted configuration of an optical component for use in an optoelectronic device, e.g. as part of an adapted optical stack (see also FIG. 4A).

The optical component 200 may include, in general, a substrate 202 and a lens element 204. The substrate 202 may include or may be made of any suitable refractive material, such as a glass (e.g., borosilicate glass or alumina borosilicate glass), optical filter glass, an epoxy, a polymer, or a PCB material (e.g., G10 or FR4), where PCB stands for Printed Circuit Board. In some aspects, the substrate 202 may be a wafer (e.g., an epoxy wafer) or a sheet. For example, the substrate 202 may be a substrate for wafer-level fabrication, e.g. a substrate that allows carrying out wafer-level fabrication of the lens element 204 using the substrate 202 as support for forming the lens element 204. The lens element 204 may include any suitable material for wafer-level optics fabrication. For example, the lens element 204 may include or may be made of a polymer material, e.g. any suitable UV curable polymer material, such as a thiol-ene based polymer, an acrylate resin, an epoxy based polymer, and the like.

In the present disclosure the term “lens element” is used to describe a lens part of an optical component and configured to implement a predefined lens function. A lens element may thus be configured to manipulate light passing through the lens element according to the corresponding lens function for which the lens element is designed. A lens element may illustratively be an optical surface configured (e.g., shaped) to define a predefined manipulation of the light. For example the predefined lens function may include focusing light, diffracting light, collimating light, diverging light, projecting a light pattern, etc. A “lens element” may also be referred to herein simply as “lens”. A “lens function” may be understood as an optical manipulation of light according to the lens type of the respective lens element (e.g., concave lens, convex lens, etc.). For example, a “lens surface” may cause refraction of light that passes through the lens surface.

In general, a material of the lens 204 and/or of the substrate 202 may be adapted according to wavelength range in which the optical component 200 operates (e.g., a wavelength range for light emission/detection in a corresponding optoelectronic device). According to various aspects, the lens 204 and/or the substrate 202 may include or may be made of a material configured for the visible range (e.g., the range from 380 nm to 700 nm), the infrared wavelength range (e.g., from 780 nm to 1300 nm), or the near-infrared range (e.g., the range from 800 nm to 2500 nm). As a numerical example, the lens 204 may include or may be made of a material configured to have a transmission greater than 90% in the above mentioned ranges, for example a transmission greater than 94%.

In some aspects, the substrate 202 may be opaque, illustratively non-transmissive. As an example, the substrate 202 may include or may be made of a material that is opaque in a predefined wavelength range, e.g. in the wavelength range in which the optical component 200 operates, e.g. one of the wavelength ranges mentioned above. As another example, the substrate 202 may be coated with an opaque layer (illustratively, an opaque coating), e.g. with a layer of a material that is opaque in the predefined wavelength range. Illustratively, the substrate 202 or the opaque layer may be substantially non-transparent (non-transmissive) for light in the predefined wavelength range. An opaque substrate 202 (e.g., intrinsically opaque, or with an opaque layer) may allow using the substrate 202 to define an aperture for the optical component 200, as discussed in further detail below. In some aspects, the substrate 202 may be configured to be opaque (illustratively, light-blocking) in the wavelength range in which the lens element 204 is configured to be transmissive. As a numerical example, the substrate 202 may include or may be made of a material configured to have a transmission less than 10% in the above mentioned wavelength ranges, for example a transmission less than 5%, for example a transmission less than 1%.

In an exemplary configuration, the material of the substrate 202 may be reflective in the predefined wavelength range, e.g. in one or more of the wavelength ranges mentioned above. For example, the material of the substrate 202 may be reflective in the wavelength range in which the lens element 204 is configured to be transmissive. As another example, the substrate 202 may include (e.g., may be coated with) a reflective layer configured to be reflective in the predefined wavelength range. In a corresponding manner as a configuration with an “opaque” substrate, a reflective substrate (e.g., intrinsically reflective, or with a reflective layer) may provide structuring the substrate to define an aperture, illustratively by reflecting back light at certain portions of the substrate 202 and allowing light to pass through other portions of the substrate 202.

It is understood that the material of the lens element 204 and/or of the substrate 202 (or the corresponding coating layers) may also be designed for other wavelength ranges, e.g. for the ultraviolet range (e.g., the range from 100 nm to 400 nm).

The dimensions of a lens element 204 (and/or of the substrate 202) may be adapted within the usual ranges of wafer-level optics techniques depending on the desired end-application of the lenses 204. As a numerical example, a thickness of the substrate 202 may be in the range from 50 µm to 1 mm, for example in the range from 200 µm to 700 µm. For example, in case of a sheet, the thickness of the sheet may be about 100 µm. In case of a wafer the thickness may be greater, e.g. in the range from 300 µm to 550 µm. In general, the substrate 202 may have a lateral extension (a thickness) in the direction parallel to the optical axis of the optical component 200 smaller than a lateral extension (a width, or diameter) in the plane perpendicular to the optical axis of the optical component 200. A thickness of the lens element 204 (e.g., a minimum thickness, at the edge or at the center depending on the lens type) may be in the range from 5 µm to 100 µm, for example in the range from 10 µm to 50 µm. As a further numerical example, a diameter of the lens element 204 (e.g., a diameter of the concave portion or convex portion) may be in the range from 100 µm to 10 mm, for example in the range from 500 µm to 1 mm.

According to various aspects, the substrate 202 may include a through-hole 206 extending through the substrate. Illustratively, a hole 206 (an open-ended cavity) may be formed that passes through the substrate 202. The through-hole 206 may thus extend over the entire thickness of the substrate 202, from a first surface 208a of the substrate 202 to a second surface 208b of the substrate 202. The through-hole 206 may thus be formed in a direction perpendicular to a main dimension of the substrate 202 (e.g., perpendicular to a width, or a diameter), illustratively, the through-hole may extend perpendicularly to a main surface of the substrate 202. The through-hole 206 may extend from a first opening in the first surface 208a (e.g., a top surface of the substrate 202) to a second opening in the second surface 208b (e.g., a bottom surface). The through-hole 206 may thus be formed by removing the material of the substrate 202 from the first surface 208a to the second surface 208b. Illustratively, the term “through-hole” may be used herein to describe an open-ended cavity formed in the substrate 202.

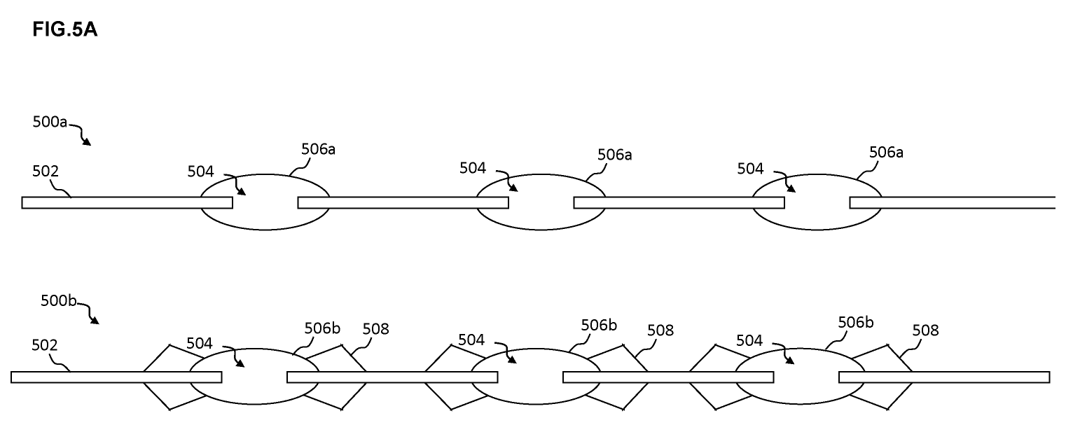

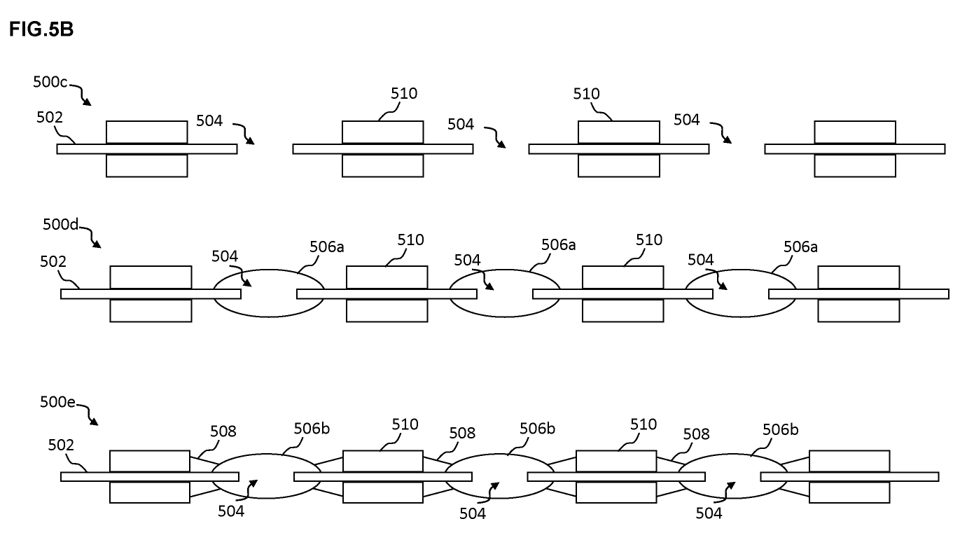

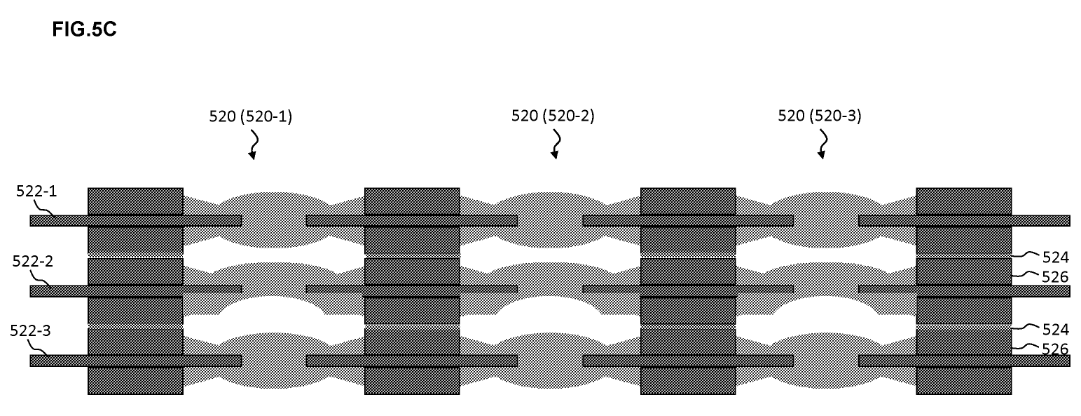

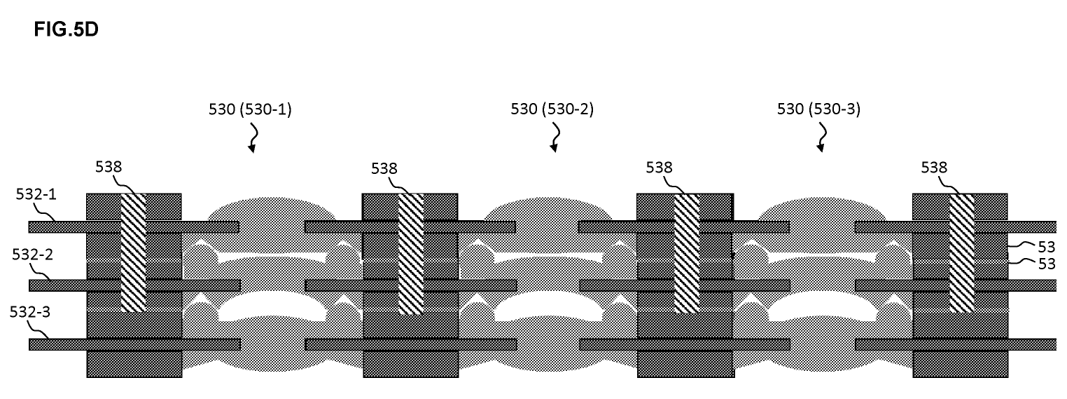

According to various aspects, the lens element 204 may be at least partially embedded in the through-hole 206. Illustratively, the material forming the lens element 204 may be disposed (at least in part) within the region defined by the through-hole 206. This configuration may result from the fabrication of the optical component 200 (see also FIG. 5A) and may facilitate the use of the (structured) substrate 202 as aperture stop for the optical element 200.

In this regard, various configurations may be provided. For example, the lens element 204 may be fully embedded in the through-hole 206. In this scenario, the sidewall of the through-hole 206 may completely surround the lens element 204, e.g. the lens element 204 may be formed fully within the through-hole 206 so that the lens element 204 does not protrude from the surface 208a, 208b of the substrate 202. This configuration may provide an easier stacking of optical components 200 to form an optical stack (see also FIG. 4A). In another exemplary configuration, the lens element 204 may be partially disposed within the through-hole 206 and partially disposed outside of the through-hole 206, as shown in FIG. 2, e.g. the lens element 204 may protrude from the through-hole 206 (at the first surface 208a and/or at the second surface 208b). This configuration may be achieved with a simpler fabrication process. In this configuration, the sidewall of the through-hole 206 may laterally surround a portion of the lens element 204 while another portion of the lens element 204 extends outside of the through-hole 206 and is thus not surrounded by the sidewall.

In various aspects, the lens element 204 may thus be fully contained within the through-hole 206, such that at least part of the sidewall of the through-hole 206 extends above the top surface of the lens element 204 and/or part of the sidewall of the through-hole 206 extends below the bottom surface of the lens element 204 (considering the direction parallel to the optical axis of the optical component 200).

In other aspects, the lens element 204 may protrude from the through-hole 206, e.g. from the first surface 208a and/or bottom surface of the substrate 208b. For example, as shown in FIG. 2, the lens element 204 may be embedded in the through-hole 206 and may have a first (top) portion protruding from the first surface 208a of the substrate 202, a second (bottom) portion protruding from the second surface 208b of the substrate 202, and a further portion within the through-hole 206. In this configuration, the lens element 204 may be disposed in part on the first surface 208a and on the second surface 208b, e.g. in correspondence of a border region of the lens element 204.

In various aspects, the lens element 204 may fill the through-hole 206, either completely (as in FIG. 2) or at least for the greatest portion of the sidewall of the through-hole 206. Illustratively, in an exemplary configuration the sidewall of the through-hole 206 may be completely covered by the material of the lens element 204. In another configuration, the sidewall of the through-hole 206 may have a first portion covered by the material of the lens element 204 and a second portion free of the material of the lens element 204, and the first portion may have a surface area (much) greater than the second portion. For example, the first portion may include at least 70% of the total surface area of the sidewall of the through-hole 206, e.g. at least 80% of the total surface area, e.g. at least 90% of the total surface area.

The lens element 204 may be disposed symmetrically with respect to the lateral extension of the through-hole 206 in the plane/direction perpendicular to the optical axis of the optical component 200. Furthermore, in some aspects, the lens element 204 may be disposed symmetrically with respect to the lateral extension of the through-hole 206 in the direction parallel to the optical axis of the optical component 200. Illustratively, the lens element 204 may be centered with respect to the through-hole 206 in the horizontal direction and in the vertical direction.

According to the configuration proposed herein the substrate 202 may be structured to define an aperture stop 212 of the optical component 200 in correspondence of the through-hole 206. Illustratively, the substrate 202 may be structured to form an aperture in correspondence of the through-hole 206 to define a confinement region for light passing through the lens element 204. The aperture stop 212 may thus partially block light and partially allow light to pass through the aperture stop 212 (and, accordingly, through the lens element 204), during an operation of the optical component 200 (e.g., an operation of the corresponding optoelectronic device). Illustratively, the substrate 202 may be structured to define an aperture so that, in operation, the substrate 202 may block (or reflect away) part of the light, and may allow another part of the light to pass through the aperture defined by the structuring of the substrate 202.

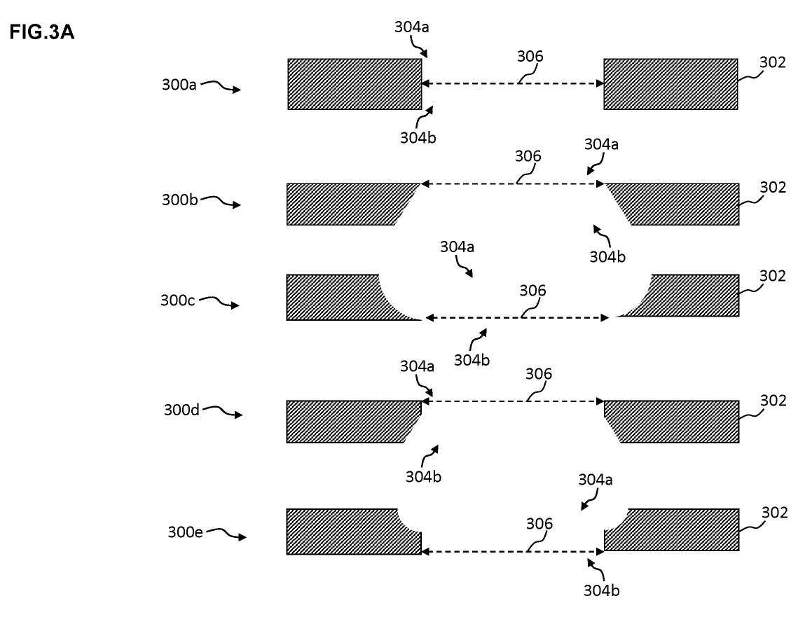

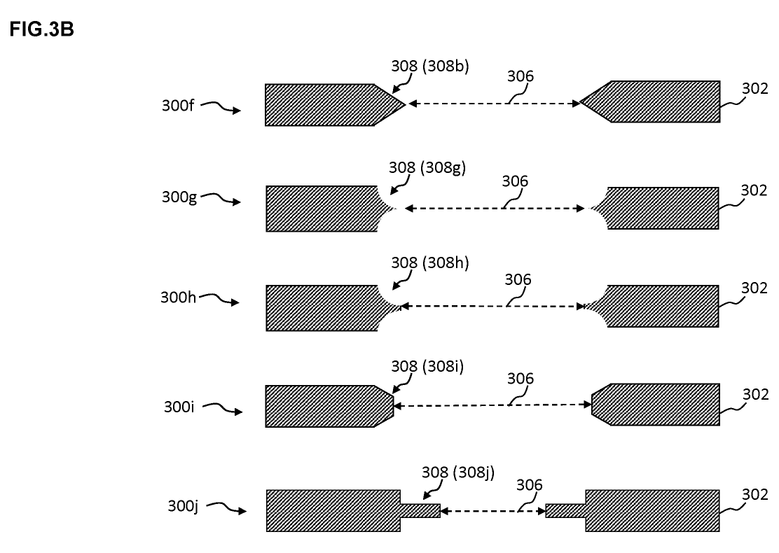

By way of illustration, the substrate 202 may include a structuring in correspondence of the through-hole 206 that limits the amount of light that may pass through the lens element 204, e.g. the amount of light that the optical component 200 may collect. In this configuration, the aperture stop 212 may be understood as a structured portion of the substrate 202 whose lateral extension (e.g., the diameter) limits the range of angles over which the optical component 200 may collect light. The structuring of the substrate 202 allows thus integrating such element of the optical component 200 directly in its structure, without separate (additional) layers or optical elements. The aperture defined by the substrate 202 may be adapted according to an intended application of the optical component 200, e.g. according to an intended amount of light that should be allowed to pass through the lens element 204 in operation. Various possible configurations may be provided to form the aperture stop 212 via a structuring of the substrate 202, and will be described in further detail in relation to FIG. 3A and FIG. 3B.

The aperture stop 212 defined by the structuring of the substrate 202 may thus have a lateral extension (e.g., a diameter) less than a lateral extension (e.g., a diameter) of the lens element 204. In the direction perpendicular to the optical axis of the optical component 200 (illustratively, the direction in the plane parallel to the main surface of the substrate 202), the substrate 202 may be structured to form the aperture stop 212 with a shorter lateral extension than the lens element 204, to limit the amount of light that may pass through the lens element 204. For example, the lens element 204 may include a lens portion and a border portion (e.g., a yard, resulting from the fabrication), and the aperture stop 212 may have lateral extension less than the extension of the lens portion. The lens portion may be the part of the lens element 204 configured to implement a predefined optical function, e.g. converging light, diverging light, collimating light, etc.

In principle, the configuration proposed herein may be applied to any suitable type of lens element 204. As examples, the lens element 204 may be a convex lens, a concave lens, a Fresnel lens, a microlens array, or any other type of lens that may benefit from the integration of an aperture stop 212 via a structuring of a substrate 202 on/in which the lens is disposed/formed.

As discussed above, the lens element 204 may be disposed, at least in part, within the through-hole 206. As an exemplary configuration, the lens element 204 may include a (first) curved surface 210a, e.g., a concave surface or a convex surface, e.g. defining the lens portion of the lens element 204, disposed at a first side of the lens element 204. The curved surface 210a may be disposed at least partially outside of the through-hole 206, e.g. the curved surface 210a may extend in part above the level of the first surface 208a or the second surface 208b and in part below the level of the first surface 208a or the second surface 208b (along the direction of the optical axis of the optical component 200). As another example, the curved surface 210a may be disposed fully outside of the through-hole 206, e.g. the curved surface 210a may be disposed fully above the level of the first surface 208a or the second surface 208b. As a further example, the curved surface 210a may be disposed fully inside of the through-hole 206, e.g. the curved surface may be disposed fully below the level of the first surface 208a or the second surface 208b.

The disposition of the lens element 204 and its configuration with respect to the through-hole 206 may be adapted according to the intended application of the optical component 200, e.g. an intended stacking, an intended integration within the housing of an optoelectronic device, and the like. It is understood that the aspects described in relation to a curved surface 210a of the lens element 204 may apply in a corresponding manner to the scenario in which the lens element 204 includes a plurality of curved surfaces disposed at the same side of the lens element 204, e.g. to the scenario in which the lens element 204 is or includes an array of lenses (e.g., an array of micro-lenses). In this configuration, the curved surfaces of the micro-lenses may (all) be disposed fully inside, or fully outside, or partially inside and partially outside of the through-hole 206.

In various aspects, the lens element 204 may include a further (second) curved surface 210b disposed at an opposite side of the lens element 204 with respect to the first curved surface 210a (along the optical axis of the optical component 200). Illustratively, the curved surface 210a and the further curved surface 210b may face towards opposite directions along the optical axis of the optical component 200. The further curved surface 210b may be, for example, a convex surface or a concave surface, further defining the lens portion of the lens element 204. In a corresponding manner as the first curved surface 210a, the further curved surface 210b may be disposed partially outside of the through-hole 206, or fully outside of the through-hole 206, or fully inside of the through-hole 206.

The first curved surface 210a and the second curved surface 210b may have the same relative disposition with respect to the through-hole 206, or may be disposed in different manners. For example, the first curved surface 210a and the second curved surface 210b may both be disposed partially outside of the through-hole 206, or may both be disposed fully outside of the through-hole 206, or may both be disposed fully inside of the through-hole 206. As another example, one of the first curved surface 210a or the second curved surface 210b may be disposed partially outside of the through-hole 206 and the other one of the first curved surface 210a or the second curved surface 210b may be disposed fully inside or fully outside of the through-hole 206. As a further example, one of the first curved surface 210a or the second curved surface 210b may be disposed fully inside of the through-hole 206 and the other one of the first curved surface 210a or the second curved surface 210b may be disposed fully outside of the through-hole 206. In other aspects, the lens element 204 may have a curved surface and a planar surface. It is understood that the possible configurations discussed in relation to the lens element 204 with two curved surfaces may apply in a corresponding manner to a configuration in which the lens element 204 has a curved surface and a planar surface.

In various aspects, the lens element 204 may be at least partially disposed on the surface of the substrate 202, e.g. on the first surface 208a and/or the second surface 208b. This may be the case, for example, in which the lens element 204 protrudes outside of the through-hole 206, and a border portion of the lens element 204 is disposed on the surface of the substrate 202. In an exemplary configuration, the portion of the lens element 204 disposed on the surface of the substrate 202 may be a yard resulting from the fabrication, illustratively a reservoir of excess material residue from the fabrication of the lens element 204 (see also FIG. 5A). The presence of a portion of the lens element 204 on the surface of the substrate 202 may enhance the robustness of the arrangement, e.g. the robustness of the adhesion between the lens element 204 and the substrate 202.

According to various aspects, the sidewall(s) of the through-hole 206 may be configured to have anti-reflective properties (e.g., in the wavelength range of light in which the optical component 200 should operate). Illustratively, the sidewall(s) of the through-hole 206 may be configured to be anti-reflective for light in the predefined wavelength range. As an example, the sidewall of the through-hole 206 (e.g., at least one sidewall, or each sidewall) may have a coating of an anti-reflective layer, e.g. a coating with a plurality of thin layers of different refractive indices to suppress reflection. As another example, the sidewall of the through-hole 206 (e.g., at least one sidewall, or each sidewall) may have anti-reflection structures, e.g. nanostructures, formed in the sidewall (e.g., via etching). For example, the sidewall of the through-hole 206 may be structured to include moth-eye anti-reflection structures. As another exemplary configuration, the sidewall(s) of the through-hole 206 may be configured to absorb light. As an example, the sidewall of the through-hole 206 (e.g., at least one sidewall, or each sidewall) may have a coating of a light-absorbing material. A sidewall with low reflectance/light-absorbing capabilities may reduce or prevent disturbances caused by stray light, which could otherwise degrade the quality of an imaging process.

As mentioned above, the substrate of the optical component may be structured in various manners to define the aperture. As a first possibility (see FIG. 3A), the substrate may be structured so that one of the openings corresponding to the through-hole is or defines the aperture. In this configuration, the selected opening may have a smaller lateral extension (e.g., a smaller diameter) compared to the other opening, and may thus cause a corresponding reduction of the region through which light may propagate. As a second possibility (see FIG. 3B) the substrate may be structured to form the aperture within the through-hole, e.g. in the middle of the through-hole or at any other suitable position at a distance from the openings. In this configuration, the substrate may be structured to form a protrusion that reduces the size of the through-hole to confine the light. This second configuration allows a precise positioning of the aperture at a desired location within the arrangement

In general, for the various configurations, the size of the aperture may be adapted according to the intended application of the optical component. Illustratively, the size (e.g., the diameter) of the aperture, i.e. the size of the region through which light is allowed to propagate, may be adapted according to the intended use of the optical component, e.g. according to the size of the corresponding optoelectronic device, according to a desired confinement for the light, etc. As a numerical example, a size of the aperture, e.g. a lateral extension (e.g., a diameter) of the aperture in the direction perpendicular to the optical axis of the optical component may be in the range from 100 µm to 1000 µm, for example in the range from 250 µm to 750 µm, for example the lateral extension may be 350 µm or 610 µm.

In a corresponding manner, for the various configurations, the shape of the aperture may be adapted according to the intended application of the optical component. Illustratively, the substrate may be structured to define any suitable shape for the aperture, e.g. any suitable profile or perimeter in the plane perpendicular to the optical axis of the optical component. As possible examples, the aperture defined by the structuring of the substrate may have a circular shape, a square shape, a rectangular shape, an elliptical shape, or any suitable polygonal shape. In an exemplary configuration, the aperture may have a shape with rotational symmetry around the optical axis of the optical component, thus providing more uniform optical properties.

FIG. 3A and FIG. 3B show various possible configurations 300a-300j of the structuring of a substrate 302 to define an aperture for a lens element of an optical component. Illustratively, FIG. 3A and FIG. 3B illustrate possible configurations of the substrate 202 described in relation to FIG. 2. In particular, FIG. 3A shows possible configuration for the design in which the structuring defines the aperture at one of the openings of the surface of the substrate. FIG. 3B shows possible configuration for the design in which the structuring defines the aperture at a distance from the openings (and from the surface). The configurations in FIG. 3A and FIG. 3B have been found suitable to implement the strategy proposed herein, e.g. in the context of wafer-level fabrication. It is however understood that also other types of structuring (e.g., other shapes, other positions of the aperture, etc.) may be provided.

Furthermore, for the sake of clarity in FIG. 3A and FIG. 3B only the substrate 302 is shown, including a first opening 304a in a first surface (e.g., top surface) and a second opening 304b in a second surface (e.g., a bottom surface) that define a through-hole extending through the substrate 302. Other possible components, e.g. a lens element, a coating layer, etc. are not illustrated, but it is understood that the aspects described in relation to FIG. 3A and FIG. 3B may apply to any of the configurations discussed in relation to FIG. 2.

According to the configurations 300a-300e in FIG. 3A, the substrate 302 may be structured such that at least one of the first opening 304a and/or the second opening 304b defines the aperture stop 306 of the optical component. In this scenario, the structuring of the substrate 302 may include dimensioning one of the openings 304a, 304b (or both openings 304a, 304b) with respect to the lens portion of the lens element so that, during an operation of the optical component, part of the light is blocked (e.g., blocked or reflected) by the substrate 302 in correspondence of the opening 304a, 304b that defines the aperture 306 and part of the light is allowed to pass through the aperture 306. Illustratively, the structuring may include defining a lateral extension of one of the openings 304a, 304b (or both openings 304a, 304b) less than a lateral extension of the lens element (e.g., of the lens portion of the lens element).

In a simple (first) configuration 300a, this approach may be implemented with a standard through-hole, which may provide the simplest configuration for manufacturing. In this configuration 300a, the first opening 304a and the second opening 304b may have the same lateral extension and the same shape (in the plane normal to the optical axis of the optical component). This configuration may be provided, for example, with a lens element whose lens portion is greater than the extension of the through-hole, e.g. for a lens element that protrudes from the through-hole, and which may have a border portion disposed on the surface(s) of the substrate 302.

In another configuration 300b, 300c the structuring may include forming the through-hole with a tapered profile. In this scenario, the substrate 302 may be structured such that a sidewall of the through-hole has a tapered profile from one opening 304a, 304b to the other opening 304a, 304b, so that one of the openings 304a, 304b has a shorter lateral extension in the plane perpendicular to the optical axis of the optical component with respect to the other opening 304a, 304b. Illustratively, the through-hole may have an entrance dimension (e.g., an entrance diameter) that is smaller than an exit dimension (e.g., an exit diameter) in view of the structuring of the substrate 302. The tapered profile may provide a gradual reduction of the size of the through-hole from the entrance opening (e.g., the second opening 304b in a second configuration 300b, or the first opening 304a in a third configuration 300c) to the exit opening (e.g., the first opening 304a, or the second opening 304b).

In an exemplary configuration, the through-hole may be a frusto-conical through-hole, in which the opening 304a at the tip of the cone defines the aperture 306 of the optical component. Analogous considerations may apply to the case in which the shape of the openings 304a, 304b is not circular. In this scenario at least one sidewall or each sidewall of the through-hole may have a tapered profile to define the aperture 306 at one of the openings 304a, 304b.

The sidewall(s) of the through-hole may have any suitable tapered profile, e.g. a linear tapered profile defining a linear reduction of the lateral extension of the through-hole (configuration 300b), a parabolic tapered profile defining a parabolic reduction of the lateral extension of the through-hole (configuration 300c), an exponential tapered profile defining an exponential reduction of the lateral extension of the through-hole, and the like.

In general, a tapered profile for the through-hole allows avoiding the so-called “vignetting”. Illustratively, the tapered profile enhances the light collection capabilities of the optical component at higher field angles, e.g. by avoiding that an excessive amount of light is blocked (cut out) at higher field angles.

The parabolic tapered profile may be a meniscus-shaped profile, which is a type of structuring that may be achieved with high volume production due to high scalability of photolithographic processing. In this configuration 300c, the substrate 302 may be structured such that the through-hole has a sidewall (e.g., at least one sidewall, e.g. each sidewall) having a meniscus-shaped profile from one opening 304a to the other opening 304b to define the reduced lateral dimension in the direction perpendicular to the optical axis for one of the openings 304b.

The tapered profile may be adapted to provide any suitable gradual reduction of the lateral extension of the through-hole, e.g. taking into consideration the thickness of the substrate 302, the size of the openings 304a, 304b, the desired light confinement, etc. As a numerical example, considering a linear tapered profile, a sidewall of the through-hole (e.g., at least one, or each sidewall) may define an angle greater than 0° and less than 90° with the optical axis of the optical component, for example an angle in the range from 10° to 60°, for example an angle in the range from 20° to 45°.

In a slightly adapted configuration 300d, 300e to provide a gradual reduction of the size of the through-hole, the substrate 302 may be structured to provide a single-side chamfered profile for the sidewall of the through-hole (e.g., at least one, or each sidewall) from one opening 304a, 304b to the other opening 304a, 304b. The chamfered profile may illustratively include the sidewall having a tapered portion (from the entrance opening) followed by a flat portion from the end of the tapered portion towards the (exit) opening 304a, 304b. The tapered portion may have, for example, a linear profile as shown in a fourth configuration 300d, or a parabolic profile as shown in a fifth configuration 300e, or any other suitable tapered profile.

The gradual reduction of the size of the through-hole may allow a smooth transition from the entrance opening to the exit opening, which enables a smoother manipulation of the light. It is however understood that in principle also a step-like configuration may be provided, in which the size of the through-hole varies in a step-like manner from the lateral extension of the entrance opening 304a, 304b to the lateral extension of the exit opening 304a, 304b.

According to the configurations 300f-300j in FIG. 3B, the substrate 302 may be structured to form at least one protrusion 308 extending in the through-hole to define the aperture stop 306. In this type of configuration, the openings corresponding to the through-hole may be larger (wider) than the aperture 306 defined by the protrusion 308, so that the confinement of the light is achieved by the protrusion 308 partially blocking (e.g., back-reflecting) light during an operation of the optical component. By way of illustration, this type of configuration may include structuring the substrate 302 so that a protrusion 308 extends from the sidewall of the through-hole towards the interior (e.g., towards the center) of the through-hole.

In general, in this configuration, the structuring may include forming a narrower passage for light propagation within the through-hole with respect to the size of the openings 304a, 304b. In this scenario, the lateral extension of the through-hole may vary from a first value at the entrance opening, to a second (smaller) value in correspondence of the protrusion 308 (and of the aperture 306), to a third value in correspondence of the exit opening (e.g., equal to the first value).

In this configuration, at least part of the sidewall of the through-hole may extend towards the interior of the through-hole to restrict the size and form the aperture 306. In general, the protrusion 308 may be formed with any suitable shape or profile, e.g. according to fabrication considerations, to the desired light confinement, etc. In FIG. 3B various examples are illustrated which may be conveniently fabricated in the context of wafer-level processing, but it is understood that also other profiles or shapes may be provided. Furthermore, in FIG. 3B configurations are shown in which the substrate 302 is structured to provide a protrusion 308 all around the through-hole, but the aspects described herein may apply in a corresponding manner to a case in which the substrate 302 is structured to provide the protrusion 308 on only part of the perimeter of the through-hole, e.g. half of the perimeter, as an example. Furthermore, in case the through-hole has a non-circular profile, the substrate 302 may be structured to define the protrusion 308 in correspondence of at least one sidewall, e.g. in correspondence of each sidewall, of the through-hole.

As an example, in a sixth configuration 300f, the protrusion 308f may have a double-sided tapered profile. In this configuration, the protrusion 308f may have a tapered profile from an edge of the through-hole (at one opening) towards the interior of the through-hole (e.g., the center) and from the interior of the through-hole to the edge of the through-hole (at the other opening). Illustratively, the lateral extension (e.g., the diameter) may gradually decrease from a first opening to a first position within the through-hole (e.g., a first height coordinate, for example at the middle of the through-hole) and may gradually increase again from the first position to the second opening. The tapered profile may be, for example, a linear tapered profile as shown in FIG.3B or any other suitable tapered profile.

As another example, in a seventh configuration 300g or eighth configuration 300h, the protrusion 308g, 308h may have a meniscus-shaped profile (illustratively, a parabolic tapered profile). In this configuration, the structuring of the substrate 302 may include a first meniscus from an edge of the through-hole (at one opening) towards the interior of the through-hole (e.g., the center) and a second meniscus (with opposite curvature) from the interior of the through-hole to the edge of the through-hole (at the other opening). In this case, the gradual decrease/increase in the lateral extension of the through-hole may have a meniscus-shaped profile.

As a further example, in a ninth configuration 300i, the protrusion 308i may have a chamfered profile, e.g. a double-sided chamfered profile. In this configuration, the structuring of the substrate 302 may include a first tapered portion from an edge of the through-hole (at one opening) towards the interior of the through-hole (e.g., the center), a flat portion, and a second tapered portion from the interior of the through-hole to the edge of the through-hole (at the other opening). The tapered portion may have any suitable profile, e.g. linear, parabolic, exponential, etc.

As a further example, in a tenth configuration 300j, the protrusion 308j may have a step-like profile. In this configuration, the lateral extension may have a first value along a first portion of the through-hole (from an opening to the protrusion 308j), a second (smaller) value in correspondence of the protrusion 308j, and a third value along a second portion of the through-hole (from the protrusion 308j to the other opening), e.g. the third value may be equal to the first value. In another exemplary configuration, the step-like profile may include more than one step, e.g. a plurality of steps gradually varying the size of the through-hole from an initial size to the (reduced) size of the aperture 306.

As mentioned above, optical components may be stacked together to provide an optical stack (also referred to herein as optical module) in which the type of optical components (e.g., the type of lenses) and the order of their disposition may provide achieving a particular optical function for light manipulation, e.g. for focusing, collimating, and the like. FIG.4A shows an optical stack 400 in a schematic representation, according to various aspects. In general, the optical stack 400 may include a plurality of optical components, at least one of which is configured as described herein.

In the exemplary configuration in FIG. 4A, the optical stack 400 may include a first optical component 402-1, a second optical component 402-2, and a third optical component 402-3. It is however understood that the optical stack 400 may include any suitable number of optical components depending on the desired optical functionality, e.g. two, three, four, five, ten, or more than ten optical components. Furthermore, for the purpose of illustrating the principles of the optical stack 400 the optical components 402-1, 402-2, 402-3 are shown as having the same configuration, e.g. the same lens element. It is however intended that each optical component may be configured to provide in combination with the other optical components the target optical functionality. Thus, the lens elements of different optical components 402-1, 402-2, 402-3 may be configured in the same manner, or in different manners (e.g., one may be a convex lens, one may be a concave lens, etc.) to achieve the target optical functionality.

In general, at least one optical component 402-1, 402-2, 402-3 may be configured as proposed herein, e.g. according to any of the possible configurations discussed in relation to FIG. 2 to FIG. 3B. In some aspects, each optical component 402-1, 402-2, 402-3 may be configured as proposed herein, or a subset of optical components 402-1, 402-2, 402-3 may be configured as proposed herein (e.g., more than one but not all optical components).

In general, the optical components 402-1, 402-2, 402-3 may be coaxially aligned with respect to one another. Illustratively, the optical components 402-1, 402-2, 402-3 may be disposed (aligned) along the optical axis of the optical stack 400. The individual optical axes of the optical components 402-1, 402-2, 402-3 may (fully) overlap with one another, illustratively the individual optical axes may be aligned with one another. Further illustratively, the optical components 402-1, 402-2, 402-3 may be centered around the optical axis of the optical stack 400.

The stacking of the optical components 402-1, 402-2, 402-3 may be carried out in any suitable manner depending on the individual configurations of the optical components. In an exemplary configuration, as shown in FIG. 4A, the optical stack 400 may include a spacer element 404 disposed between adjacent optical components (e.g., a first spacer element 404 between the first optical component 402-1 and the second optical component 402-2, a second spacer element 404 between the second optical component 402-2 and the third optical component 402-3, etc.). A spacer element 404 may also be referred to herein as spacing element, or simply as spacer.

A spacer element 404 may provide structural support to the lens stack. Furthermore, the dimensions (e.g., the height) of a spacers 404 may be selected to facilitate the adaptation of some properties of the optical stack 400, e.g. to adapt the lens to lens distance and accordingly the effective focal length of the optical stack 400. For example, a spacer aperture diameter and/or a thickness (illustratively, a sidewall thickness) may be adapted according to desired properties for the optical stack 400. A spacer element 404 may include or may be made of any suitable material, for example a polymer material or a glass material. For example a glass material may provide more robust mechanical and thermal stability of the optical stack 400.

In an exemplary configuration, a spacer 404 may include or may be made of an opaque material (e.g., the same material as the substrate of an optical component 402-1, 402-2, 402-3) or another type of opaque material, e.g. opaque in the wavelength range in which the optical stack 400 operates. In another exemplary configuration, a spacer 404 may include or may be made of a transparent material, e.g. transparent in the wavelength range in which the optical stack 400 operates. In some aspects, a spacer 404 may be coated with an opaque layer or a reflective layer. In general, an opaque material for the spacer element 404 may be preferred in most application as it can function as a stray light blocker and or channel separating structure, separating the optical path from the environment or a from a second optical path in close proximity. In some aspects, a spacer 404 may be integrated with the substrate of an optical component. For example, the spacer 404 and the substrate may form a monolithic structure. As another example, the spacer 404 may be formed on the substrate, e.g. as a plurality of laminated layers.

In another configuration, the optical stack 400 may include optical components coupled with one another without a spacer 404 therebetween. This configuration may be provided, for example, in case one optical component (or two adjacent optical components) includes the corresponding lens element contained within the corresponding through-hole, e.g. at least at the side facing the other optical component. In this scenario, the substrate itself may serve as spacer between the optical components, illustratively the substrate of the first optical component may be disposed (directly) on the substrate of the other optical component due to the lens element (or both lens elements) being confined within the respective through-hole.

In some aspects, the optical stack 400 may further include an adhesive layer (not shown) disposed between adjacent optical components, e.g. in correspondence of the spacer coupling the optical components. Illustratively, the adhesive layer may be disposed between the spacer 404 and the adjacent optical components. In another configuration, the adhesive layer may be disposed between two spacer elements corresponding to different optical components, and the respective spacer elements may be integrated within the corresponding substrates of the respective optical components. In a further configuration, the adhesive layer may be disposed directly between the substrates of adjacent optical components. As another exemplary configuration, the optical stack 400 may further include an alignment element to facilitate an alignment of the optical components, e.g. during a fabrication of the optical stack 400 (see also FIG. 5D).

The respective aperture defined by the substrate of an optical component 402-1, 402-2, 402-3 may be adapted depending on the intended operation of the stack. In an exemplary configuration, the apertures of the different optical components 402-1, 402-2, 402-3 may have the same configuration, e.g. in terms of shape, lateral extension, profile, etc. In another exemplary configuration, the apertures of the different optical components 402-1, 402-2, 402-3 may have different configurations.

For example, the apertures of the outermost optical components 402-1, 402-3 (e.g., the optical component 402-1 at the top of the stack and/or the optical component 402-3 at the bottom of the stack) may have a different lateral extension in the plane/direction perpendicular to the optical axis with respect to the apertures of the intermediate optical components 402-2 of the stack. As an example, the aperture defined by the structuring of the substrate of an intermediate optical component (e.g., the second optical component 402-2) may have a lateral extension less than the lateral extension of the apertures of the outermost optical components 402-1, 402-3. As another example, the aperture defined by the structuring of the substrate of an intermediate optical component (e.g., the second optical component 402-2) may have a lateral extension greater than the lateral extension of the apertures of the outermost optical components 402-1, 402-3.

In an exemplary configuration, the apertures of the outermost optical components 402-1, 402-3 may have the same lateral extension in the plane/direction perpendicular to the optical axis, and such lateral extension may be different from the lateral extension of the aperture of an intermediate optical component 402-2. For example, apertures of the outermost optical components 402-1, 402-3 may have the same lateral extension being greater (or less) than the lateral extension of the aperture of an intermediate optical component 402-2.

FIG.4B shows an optical stack 450 in a schematic representation, according to various aspects. The optical stack 450 may be an exemplary realization of the optical stack 400, and may include a plurality of optical elements 452 configured as proposed herein, illustratively a plurality of aperture substrates structured to defined an aperture stop for a corresponding lens element. In the exemplary configuration in FIG. 4B, the optical stack 450 may include a first optical component with a lens with two convex surfaces, a second optical component with a lens with a convex surface and a concave surface, and a third optical component with a lens with two convex surfaces.

The optical components 452 may be separated from one another via respective spacer elements 454. For example each optical component 452 may include respective spacer elements at the two surfaces of the substrate, e.g. integrally formed with the substrate. For example, an aperture substrate with spacing elements may be formed from a single material or may be a combination of individual foils laminated on top of each other. The optical components 452 may be coupled with one another via adhesive layers 456 disposed between the corresponding spacer elements 454 to ensure a robust adhesion of the optical components 452.

The aspects discussed in relation to FIG. 2 to FIG. 4B have been illustrated with reference to individual (e.g., singulated) optical components, or an individual optical stack. In general, however, the fabrication of the optical components and of corresponding optical stacks may be carried out in parallel for multiple components/stacks, e.g. at the wafer level. In this regard, FIG. 5A andFIG. 5B show a parallel fabrication of a plurality of optical components, and FIG. 5C and FIG. 5D show a parallel fabrication of a plurality of optical stacks, according to various aspects. It is understood that the aspects described in relation to the individual optical components/optical stacks may apply in a corresponding manner to multiple optical components/optical stacks, and vice versa.

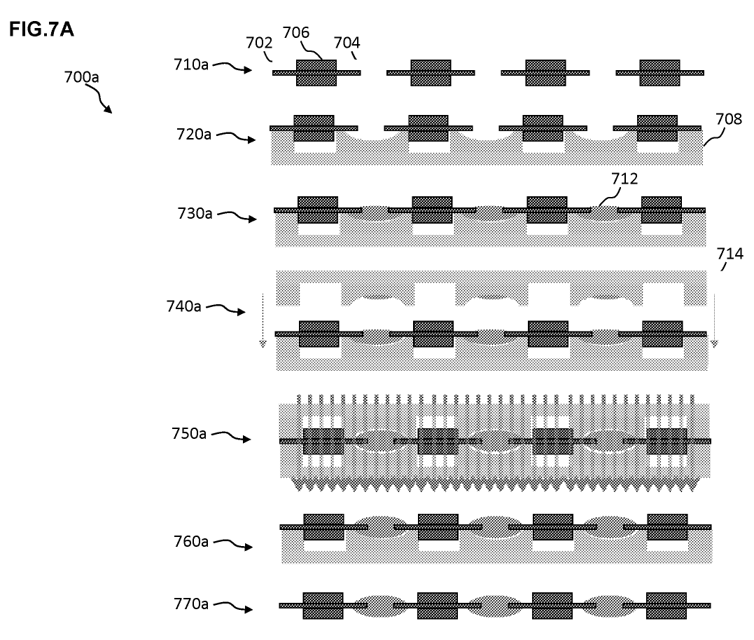

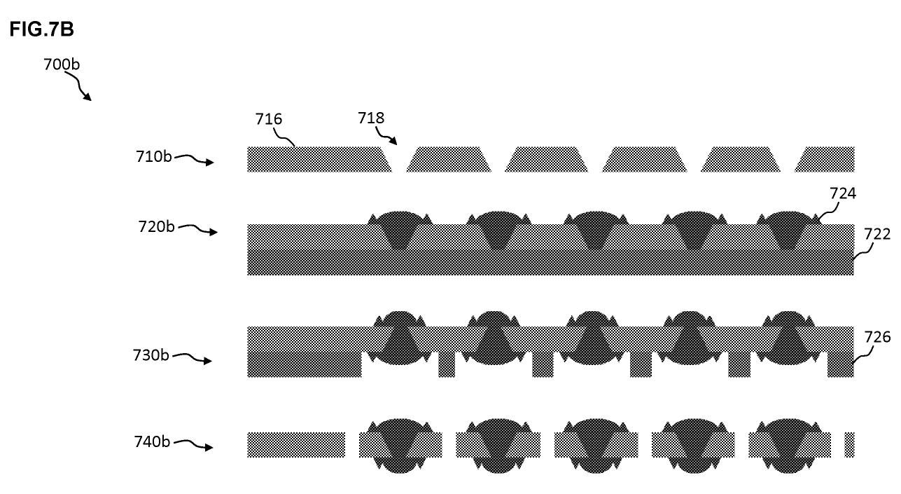

FIG. 5A shows two possible configurations 500a, 500b. In a first configuration 500a, a substrate 502 (e.g., a wafer, or a sheet) is structured to define a plurality of through-holes 504 in which corresponding lens elements 506a are disposed (e.g., embedded). Illustratively, the substrate 502a may be a connecting aperture substrate, e.g. an opaque connecting aperture sheet, including a plurality of lens elements 506a for which the substrate 502a is structured to define a corresponding aperture stop (e.g., according to any of the configurations discussed in relation to FIG. 2 to FIG. 3B). The lens elements 506a may be for example, molded lens elements made of a transparent material (e.g., a transparent epoxy). In a second configuration 500b the lens elements 506b may additionally include a yard portion 508, e.g. a molded yard structure. The yard portion 508 may be a volume reservoir for material to flow during the fabrication (e.g., the molding) of the lens elements 506b (see also FIG. 7A and FIG. 7B).

FIG. 5B shows further configurations 500c, 500d, 500e in which the optical components further include spacer elements 510 to facilitate the stacking for creating an optical module. For example, the spacer elements 510 may be integrated in the substrate 502 in correspondence of the through-holes 504, e.g. disposed to surround (at least partially) the through-holes 504. In this scenario, as shown for the fifth configuration 500e, the spacer elements 510 may have the additional function of confining the yard volume. Illustratively, the spacer elements 510 may define the volume into which the lens elements 506b may be formed, e.g. molded, thus confining the yard portion 508 of the lens elements 506b.

FIG. 5C shows a configuration with a plurality of optical stacks 520, e.g. a first optical stack 520-1, a second optical stack 520-2, and a third optical stack 520-3 that are interconnected to one another. Illustratively, the fabrication of the optical stacks 520 may be carried out in parallel by stacking on top of each other the substrates corresponding to the optical components forming the stack, e.g. first substrate 522-1, second substrate 522-2, and third substrate 522-3. The substrates 522-1, 522-2, 522-3 may be coupled with one another via adhesive layers 524 disposed between the respective spacer elements 526 integrated in the substrates 522-1, 522-2, 522-3. As discussed above, the substrate 522-1, 522-2, 522-3 with integrated spacer elements 526 may provide, as an additional functionality, a shielding of light, in which light remains confined within an optical channel, and also prevents or reduces possible deteriorating effects caused by stray light.

FIG. 5D shows a configuration with a plurality of optical stacks 530, e.g. a first optical stack 530-1, a second optical stack 530-2, and a third optical stack 530-3 that are interconnected to one another. Illustratively, the corresponding substrates 532-1, 532-2, 532-3 may be stacked on top of one another, e.g. by connecting the substrates via adhesive layers 524 disposed between the respective spacer elements 526 integrated in the substrates 532-1, 532-2, 532-3. In the configuration in FIG. 5D, the optical stacks 530 may further include alignment elements 538 (interlock elements) that facilitate the alignment and the coupling (e.g., the gluing) of the substrates 532-1, 532-2, 532-3. In this configuration, for example, the alignment elements 538 may be disposed on the lowermost substrate 532-3, e.g., on the spacer elements 536 of the lowermost substrate 532-3. The spacer elements 536 of the other substrates 532-1, 532-2 may be hollow (e.g., may include a through-hole extending through the height) to allow mating with the alignment elements 538 for a precise alignment. The combination of an interlock 538 for alignment during stacking and a spacing element 536 allows to separate the bond line/adhesive 534 from the alignment feature (interlock) and the lens itself. This may improve the contact of the interlock and reduce the risk of adhesive contamination of the lens substrate.

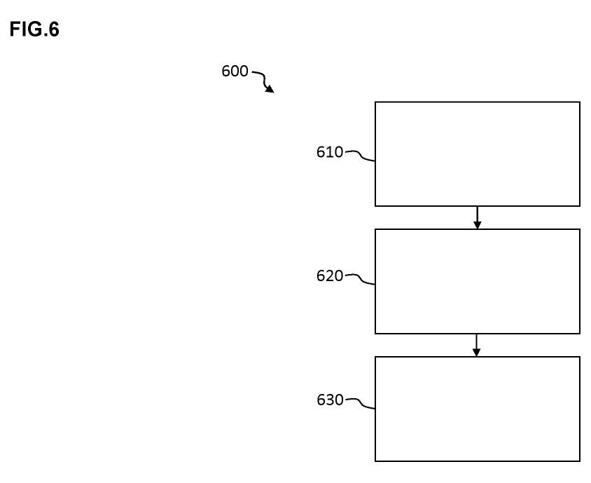

FIG. 6 shows a schematic flow diagram of a method 600 of fabricating an optical component. The method 600 may be related to the fabrication of the optical component 200 described in relation to FIG. 2 to FIG. 3B, and to the stacking of optical components to form an optical stack (e.g., the optical stack 400 in FIG. 4A). It is understood that the aspects described in connection with the optical component 200 or optical stack 400 may apply in a corresponding manner to the method 600, and vice versa. In general, the forming of the various parts of the optical component may be carried out with conventional techniques. In a preferred configuration, the forming of the various parts of the optical component may be carried out with wafer-level fabrication techniques (see also FIG. 7A and FIG. 7B).

The method 600 may include, in 610, forming a through-hole in a substrate, the through-hole extending from a first opening in a first surface of the substrate to a second opening in a second surface of the substrate. The substrate may be for example a wafer or a sheet. In some aspects, considering a parallel fabrication, the method may include forming a plurality of through-holes in the substrate, each corresponding to a respective optical component. The through-hole may be formed in any suitable manner, for example via drilling (e.g., laser drilling), micromachining, and the like.

The method 600 may further include, in 620, structuring the substrate to define an aperture stop of the optical component in correspondence of the through-hole. In general, the structuring may include shaping and/or dimensioning the substrate in correspondence of the through-hole to form an aperture that may at least partially block (or reflect back) light from passing through the lens element. Illustratively, the method may include structuring the substrate to reduce light collection of the lens element (e.g., of its lens portion).

As an example, the method 600 may include structuring the substrate such that one (or both) openings define the aperture stop of the optical component. For example, the method 600 may include structuring the substrate to provide a tapered profile (or a single-sided chamfered profile) for a sidewall of the through-hole. As another example, the method 600 may include structuring the substrate to provide a protrusion within the through-hole to define the aperture stop.

The method 600 may further include, in 630, providing a lens element in correspondence of the through-hole, e.g. a lens element at least partially embedded in the through-hole. The method 600 may include structuring the substrate such that the aperture stop has a lateral dimension (e.g., a diameter) in the direction perpendicular to an optical axis of the optical component less than a lateral dimension of the lens portion in such direction.

For example, the method 600 may include disposing or forming the lens element. As an example, forming the lens element may include disposing (e.g., depositing, printing) a material of the lens element in the through-hole (e.g., an epoxy material) and shaping the lens element, e.g. via a replication process. For example, the method 600 may include using a master tool to shape one or more curved surfaces of the lens element. Forming the lens element may further include curing the material of the lens element (e.g., via UV-irradiation).

In some aspects, the method 600 may further include carrying out a singulation of the optical component, e.g. from a larger substrate, for example via dicing. In some aspects, the method 600 may further include disposing a plurality of optical components in a coaxially aligned stack to provide an optical stack.

FIG. 7A and FIG. 7B show respective methods 700a, 700b of forming a plurality of optical components in parallel. Illustratively, the methods 700a and 700b may be exemplary realizations of the method 600 described in FIG. 6. For clarity of representation, reference signs are not repeated throughout the figure. It is understood that the aspects described in FIG. 7A and FIG. 7B are exemplary to illustrate possible fabrication techniques for an optical component as described herein, but the optical components may also be provided with different fabrication steps (e.g., different sequence of steps, different techniques, etc.).

In relation to FIG. 7A, the method 700a may include, in 710a, providing a substrate 702 (e.g., an opaque connecting aperture sheet) with a plurality of through-holes 704, and structuring the substrate to define aperture stops in correspondence of the through-holes 704. In some aspects, the method 700a may include integrating spacer elements 706 in the substrate 702 (e.g., as a monolithic arrangement, or by laminating multiple foils), e.g. to surround the through-holes 706. The structuring of the substrate 702 may define any suitable configuration of the aperture stop, as discussed in relation to FIG. 2 to FIG. 5D.

The method 700a may further include, in 720a, bringing a replication tool 708 (a bottom tool) in contact with the substrate 702. The replication tool 708 may be shaped according to the profile to be given to the lens elements, e.g. the profile of a bottom portion of the lens elements. Illustratively, the replication tool 708 may include a plurality of replication portions shaped and dimensioned to define the lens portion of the lens elements.

The method 700a may further include, in 730a, disposing lens material 712 over the replication tool 708 in correspondence of the through-holes 704. Illustratively, the method 700a may include disposing (e.g., depositing, printing) lens material 712 over the replication portions of the replication tool 708. The method 700a may further include, in 740a, bringing a further replication tool 714 (a top replication tool) in contact with the substrate 702 and in contact with the lens material 712 disposed on the bottom replication tool 708. The top replication tool 714 may be shaped according to the profile to be given to the lens elements, e.g. the profile of a top portion of the lens elements. The top and bottom replication tools may be aligned to define the desired profile for the lens elements in correspondence of the through-holes (and respective aperture stops. In some aspects, further lens material may be disposed in the top tool 714 to form the lens element between the top tool 714 and the bottom tool 708.

The method 700a may further include, in 750a, curing the lens material 712 while keeping the replication tools 708, 714 in contact with the substrate 702. For example, the method 700a may include irradiating the arrangement with UV light to cure the lens material (e.g., a UV-curable epoxy). It is understood that this step may be adapted according to the material of the lenses, e.g. the curing may be carried out via heating the substrate 702, via irradiating with other types of radiation, etc.

The method 700a may further include, in 760a and 770a, removing the replication tools 708, 714, e.g. bringing away the top replication tool 714 from the substrate 702 and bringing away the bottom replication tool 708 from the substrate 702. In some aspects, the method 700a may further include dicing the substrate 702 to separate the optical components.

In relation to FIG. 7B, the method 700b may include, in 710b, providing a substrate 716 (e.g., an epoxy wafer) with a plurality of through-holes 718, and structuring the substrate to define aperture stops in correspondence of the through-holes 718. In the exemplary configuration in FIG. 7B, the method 700b may include structuring the substrate 716 to define a tapered profile of the through-holes 718.

The method 700b may further include, in 720b, bringing a flat tool 722 in contact with the substrate 716 and forming the lens elements 724 in the through-holes 718. The flat tool 722 may provide support for the lens material within the through-holes. Forming the lens elements 724 may include disposing the lens material on the flat tool 722, shaping (e.g., molding) the lens material to define the lens profile, and curing the lens material.

The method 700b may further include, in 730b, holding the substrate 716 with the lens elements 724 with a vacuum chuck 726 and define a further lens profile at the opposite surface of the lens elements 724. For example, the method 700b may include disposing the lens material on the flat surface of the previously formed lens elements, shaping the newly dispensed lens material to define the lens profile, and curing the lens material. The method 700b may further include, in 740b, removing the substrate 716 from the vacuum chuck 726, and dicing the substrate 716 to provide the individual optical components.

The term “control circuit” (or processing circuit) as used herein may be understood as any kind of technological entity that allows handling of data. The data may be handled according to one or more specific functions that the control circuit may execute. Further, a control circuit as used herein may be understood as any kind of circuit, e.g., any kind of analog or digital circuit. A control circuit may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, […], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

### List of reference signs

100 Light-based sensing device

102 First optoelectronic device

104 Second optoelectronic device

106 Processing circuit

108 Emitted light

110 Field of view

112 Reflected light

120 Optoelectronic device

122 Optoelectronic component

124 Optical component

126 Control circuit

128 Housing

130 Substrate

200 Optical component

202 Substrate

204 Lens element

206 Through-hole

208a First surface

208b Second surface

210a First curved surface

210b Second curved surface

212 Aperture stop

300a First configuration

300b Second configuration

300c Third configuration

300d Fourth configuration

300e Fifth configuration

300f Sixth configuration

300g Seventh configuration

300h Eighth configuration

300i Ninth configuration

300j Tenth configuration

302 Substrate

304a First opening

304b Second opening

306 Aperture stop

308 Protrusion

308f Protrusion

308g Protrusion

308h Protrusion

308i Protrusion

308j Protrusion

400 Optical stack

402-1 First optical component

402-2 Second optical component

402-3 Third optical component

404 Spacer element

450 Optical stack

452 Optical component

454 Spacer element

456 Adhesive layer

500a First configuration

500b Second configuration

500c Third configuration

500d Fourth configuration

500e Fifth configuration

502 Substrate

504 Through-hole

506a Lens element

506b Lens element

508 Yard portion

510 Spacer element

520 Optical stack

520-1 First optical stack

520-2 Second optical stack

520-3 Third optical stack

522-1 First substrate

522-2 Second substrate

522-3 Third substrate

524 Adhesive layer

526 Spacer element

530 Optical stack

530-1 First optical stack

530-2 Second optical stack

530-3 Third optical stack

532-1 First substrate

532-2 Second substrate

532-3 Third substrate

534 Adhesive layer

536 Spacer element

538 Alignment element

600 Method

610 Method step

620 Method step

630 Method step

700a Method

700b Method

702 Substrate

704 Through-hole

706 Spacer element

708 Replication tool

710a Method step

710b Method step

712 Lens material

714 Replication tool

716 Substrate

718 Through-hole

720a Method step

720b Method step

722 Flat tool

724 Lens element

726 Vacuum chuck

730a Method step

730b Method step

740a Method step

740b Method step

750a Method step

760a Method step

770a Method step

What is claimed is:

1. An optical component comprising:
a substrate comprising a through-hole extending from a first opening in a first surface of the substrate to a second opening in a second surface of the substrate; and
a lens element at least partially embedded in the through-hole,
wherein the substrate is structured to define an aperture stop of the optical component in correspondence of the through-hole to, during an operation of the optical component, partially block light and partially allow light to pass through the aperture stop,
wherein the aperture stop has a lateral dimension in a direction perpendicular to an optical axis of the optical component less than a lateral dimension of a lens portion of the lens element in the direction perpendicular to the optical axis of the optical component.

2. The optical component according to claim 1,
wherein the substrate is structured such that at least one of the first opening and/or the second opening defines the aperture stop of the optical component.

3. The optical component according to claim 2,
wherein the substrate is structured such that the through-hole has at least one sidewall having a tapered profile from the first opening to the second opening such that one of the first opening or the second opening has a lateral dimension in the direction perpendicular to the optical axis of the optical component less than a lateral dimension of the other one of the first opening or the second opening in such direction.

4. The optical component according to claim 2,
wherein the substrate is structured such that the through-hole has at least one sidewall having a single-sided chamfered profile from the first opening to the second opening such that one of the first opening or the second opening has a lateral dimension in the direction perpendicular to the optical axis of the optical component less than a lateral dimension of the other one of the first opening or the second opening in such direction.

5. The optical component according to claim 1,
wherein the substrate is structured to form at least one protrusion extending in the through-hole,
wherein the at least one protrusion defines the aperture stop of the optical component.

6. The optical component according to claim 5,
wherein the at least one protrusion has a meniscus shaped profile from an edge of the through-hole towards a center of the through-hole; or
wherein the at least one protrusion has a double-sided chamfered profile from an edge of the through-hole towards a center of the through-hole; or
wherein the at least one protrusion has a double-sided tapered profile from an edge of the through-hole towards a center of the through-hole.

7. The optical component according to claim 1,
wherein the lens element is at least partially disposed on one of the first surface or the second surface of the substrate.

8. The optical component according to claim 1,
wherein the substrate is configured to be opaque in a predefined wavelength range.

9. An optical stack comprising:
a plurality of coaxially aligned optical components;
wherein at least one optical component of the plurality of optical components is an optical component according to claim 1.

10. A method of fabricating an optical component, the method comprising:
forming a through-hole in a substrate, the through-hole extending from a first opening in a first surface of the substrate to a second opening in a second surface of the substrate;
structuring the substrate to define an aperture stop of the optical component in correspondence of the through-hole to, during an operation of the optical component, partially block light and partially allow light to pass through the aperture stop; and
providing a lens element at least partially embedded in the through-hole,
wherein the aperture stop has a lateral dimension in a direction perpendicular to an optical axis of the optical component less than a lateral dimension of a lens portion of the lens element in the direction perpendicular to the optical axis of the optical component.
